(19) United States
(12) Patent Application Publication
(10) Pub. No.: US 2002/0020192 A1
(43) Pub. Date: Feb. 21, 2002

(54) Method for making a curved glass-ceramic panel by bending a green glass panel to be ceramicized and apparatus for performing said method

(76) Inventors: Hubertus Bader, Bingen (DE); Markus Vollmer, Mainz (DE); Roland Hochhaus, Mainz (DE); Ruediger Mocnik, Mainz (DE); Hans-Joachim Brenz, Sulzheim (DE)

Correspondence Address: STRIKER, STRIKER & STENBY, 103 East Neck Road, Huntington, NY, 11743, US

(21) Appl. No.: 09/922,194

(22) Filed: Aug. 3, 2001

(30) Foreign Application Priority Data
Aug. 10, 2000 (DE) 100 39 027.7-45

(51) Int. Cl. C03B 32/02

(52) U.S. Cl. 65/33.1; 65/29.11; 65/160; 65/29.12; 65/271; 65/273; 65/290

(57) ABSTRACT

The method of making a curved glass-ceramic panel by bending a green glass panel to be ceramicized avoids formation of stresses in the bending zone. The method includes performing the bending process in a heated chamber at a temperature of from 10° C. to 50° C. above a transformation temperature of the green glass panel to be bent; providing a forming body acting as a workpiece support (3) with a geometric shape according to a bend geometry of the glass-ceramic panel and tempering the forming body at the temperature of the heated chamber; bringing the forming body into effective mechanical contact with the green glass panel in a bending zone of the green glass panel to form a curved green glass panel and ceramicizing the curved green glass panel to form the curved glass-ceramic panel.

### BACKGROUND OF THE INVENTION

1. Field of the invention

The present invention relates to a method of making a curved glass-ceramic panel or plate by bending a green glass panel or plate to be ceramicized. It also relates to an apparatus for performing the method.

2. Description of the Related Art

Different applications of glass-ceramic panels require that the glass-ceramic panel be curved, as a whole or in part. For example, curved glass-ceramic panels or plates are used as attached panels for chimney ovens. Furthermore glass-ceramic panels that provide cooking surfaces are also sometimes at least partly curved, especially near their edges.

The bending of glass-ceramic panels requires special measures because of the not simple thermal treatment of form-stable heated green glass panels. Also providing them with predetermined bend radii is not without problems. For example, no attached panels for chimney ovens with small bend radii of typically less than 15 mm can be produced.

FR 2 726 350 A1 discloses, for example, a typical bending process for making curved glass-ceramic panels. Curved glass-ceramic panels are generally described as well as their application for providing cooking surfaces. A method of making curved glass-ceramic cooking surfaces is described.

The disadvantage of the known method is that the green glass panel to be curved cools to a temperature of between 400° C. and 500° C. during the bending process. Stresses and strains during the bending step and the subsequent cooling phase of the bending zone can be frozen in this way, which leads to disadvantageous and undesirable warping due to the occurring stress forces in the curved panel. This manifests itself in a deterioration of the tolerances and the planarity of the panel, which can lead to a deterioration of the cooking properties in embodiments providing cooking surfaces. It is not possible to provide a definite predetermined bend radius or radius of curvature with this prior art method.

EP 0 963 957 A1 discloses a method for making a curved glass-ceramic panel by bending the green glass panel to be ceramicized, particularly for bending the edge of an opening in the green glass panel. In a first step the green glass panel provided with the opening is pre-heated in an oven for 10 minutes at 650° C. The green glass panel is conveyed to a bending station after the pre-heating. Then it is rapidly heated in the vicinity of the edge region of the opening by two opposing gas burners in the bending station. The rapidly heated region is bent after that by means of a die to a predetermined curvature.

This known method, like the method previously described and disclosed by the French reference, has the significant disadvantage that the temperature of the green glass panel to be bent falls as it is transported from the pre-heating oven to the bending station, whereby stresses and strains can be frozen into the panel with the described disadvantages.

### SUMMARY OF THE INVENTION

It is an object of the present invention to provide a method for making a curved glass-ceramic panel of the above-described kind, i.e. by bending of the green glass panel to be ceramicized, so that the curved glass-ceramic panel can be produced with a predetermined bend radius and without stresses and strains.

It is another object of the instant invention to provide an apparatus for performing the method for making a curved glass-ceramic panel of the above-described kind, by bending of the green glass panel to be ceramicized, whereby the panel is produced with a predetermined bend radius and without stresses and strains.

According to the invention these objects are attained by a method in which the bending process is performed in a heated chamber whose temperature is 10 to 50° C. above the transformation temperature of the green glass panel to be bent, in which the green glass panel is brought into a mechanically effective contact with a forming body, which is tempered at the chamber temperature of the heated chamber and is provided with the desired curvature by the geometric shape of the forming body, in which the bending zone of the green glass panel is additionally heated and in which the green glass panel bent in this manner is ceramicized in the usual way.

Because of these features the bending process is performed in a chamber heated in a definite manner, the stress relaxation time is in the range of seconds and the strains and stresses arising in the bending process are dissipated within a short time and can no longer be frozen in the panel. Because of that no stress-induced forces arise, which impair the tolerances and planarity of the panel.

The invention permits a stress-free bending of the glass-ceramic panel so as to provide a definite predetermined bend radius.

In a first embodiment of the method according to the invention the green glass panel is additionally heated from one side in the bending zone.

More uniform and more rapid heating in this region may be obtained in a second embodiment of the invention when the green glass panel is heated from both sides in the bending zone.

An especially intensive heating occurs when the additional heating in the bending zone is provided by a gas/oxygen burner or torch.

In order to provide uniform heating the burner is moved in the vicinity of the bending zone according to the bend geometry. It is especially advantageous when I the motion of the burner is oscillatory.

The heating of the bending zone can be assisted according to another embodiment of the invention when the bending zone is heated by means of additional heat sources, such as electro-heating devices or focused IR radiation sources, in addition to the gas/oxygen burners.

When the green glass panel bears on a forming body formed as a workpiece support, the process can be performed in an advantageously simple manner.

The apparatus for making a curved glass-ceramic panel by bending a green glass panel to be ceramicized comprises a workpiece support having a geometric shape according to a bend geometry for forming the glass-ceramic panel; a heated chamber for heating the workpiece support and the green glass panel at a temperature of from 10° C. to 50° C. above a transformation temperature of the green glass panel to be bent; heating sources for local further heating of the green glass panel in a bending zone during the bending and means for ceramicizing the green glass panel to form the curved glass-ceramic panel.

According to a first embodiment the apparatus has a one-piece stationary workpiece support whose shape is formed according to the bending to be performed. This embodiment is suited for bending by means of the force of gravity.

According to a second alternative embodiment the apparatus is provided with a workpiece support comprising a plurality of parts that are movable relative to each other in order to produce the shape required during the bending.

According to another embodiment of the invention the segments are connected with each other by means of a roll mechanism with a circular segment so that the apparatus is especially suitable for upward bending advantageously with definite bending radii and behavior.

### BRIEF DESCRIPTION OF THE DRAWING

The objects, features and advantages of the invention will now be illustrated in more detail with the aid of the following description of the two preferred embodiments, with reference to the accompanying figures in which:

FIG. 1A and 1B are diagrammatic cross-sectional views of a one-piece stationary workpiece support, which is shaped according to the desired curvature of the green glass panel, and of the still planar green glass panel prior to bending in FIG. 1A and of the curved green glass panel in FIG. 1B after bending; and

FIG. 2A and 2B are diagrammatic cross-sectional views of a two-piece movable workpiece support, which has two support members in the bending zone which are movable to provide the desired bending, and of the still uncurved green glass panel in FIG. 2A and of the curved green glass panel in FIG. 2B.

### DETAILED DESCRIPTION OF THE INVENTION

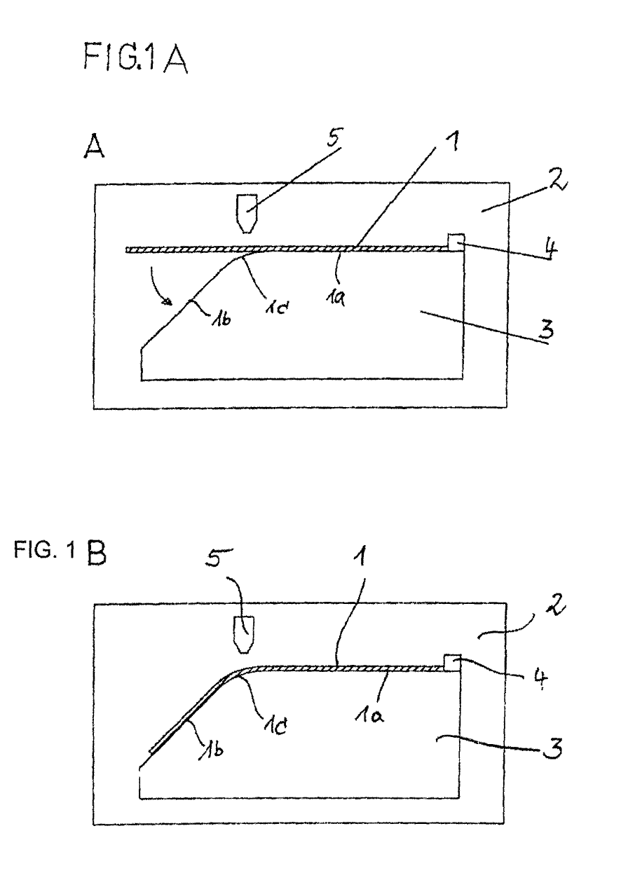

The green glass panel 1 to be bent as shown in the drawing is produced in a known manner, e.g. by rolling a glass gob, so that the production of the green glass panel and its thermal treatment is not described here in detail. The green glass panel 1 to be bent is placed on a workpiece support 3, which is made, for example, from a ceramic material, in a heated chamber, heated or oven chamber 2, whose temperature is 10° C. to 50° C. above the transformation temperature of the green glass. In the embodiment according to FIGS. 1A and 1B a one-piece stationary workpiece support 3 is provided, which is formed according to the bending to be performed, i.e. its surface produces the desired form and evenness of the glass-ceramic panel produced.

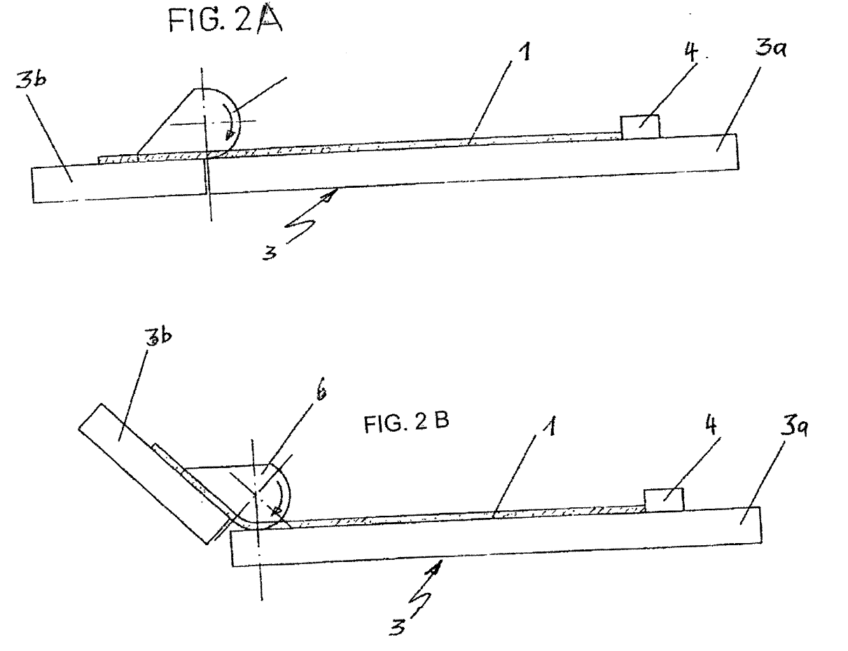

In the embodiment according to FIGS. 2A and 2B a two-piece work piece support 3 is provided, whose parts (segments) 3a and 3b are movable relative to each other for the purpose of providing the curvature. The heated chamber 2 is not shown for simplicity in FIGS. 2A and 2B, but it is used in this embodiment of the method also.

The glass-ceramic panel for the cooking surface is usually decorated and thus it is placed on the workpiece support with the undecorated side bearing on the workpiece support in order to avoid damaging the decoration.

One distinguishes upward and downward bending. Bending downward means that the open angle of the bent panel, measured between the underside of the panel and the mold is less than 180° C. Bending upward means that the bending angle is greater than 180° C. The underside of the green glass panel typically has nubs on the underside. However it can also be smooth.

The embodiment shown in FIGS. 1A and 1B has, as already been mentioned, a one-piece stationary workpiece support 3. This workpiece support is molded according to the desired shape of the green glass. The planar surface regions 1a and 1b, the radii, the curved region 1c having the curvature and other desired shapes are provided according to the tolerances required for the shaped glass. The heated chamber 2 and the workpiece 1 are tempered at from 10° C. to 50° C. over the transformation temperature of the starting glass.

The starting glass panel 1, here in cooking surface format, is placed with aid of an unshown known device on the workpiece support 3. When the glass has reached a uniform temperature, it is aligned against a stop 4 on the workpiece support 3. As soon as the glass has reached the oven temperature, the bending region is heated additionally by means of the gas burners 5 or the like to the temperature required for shaping (typically for less than 30 seconds). The glass rests on the workpiece support 3 under the influence of gravity. After less than 3 minutes the glass is rigid enough so that no additional shaping takes place during removal from the workpiece support 3 and from the oven chamber 2. The glass is placed on a carrier and cooled to room temperature.

In the embodiment according to FIGS. 1A and 1B the partially heated deformable glass rests on the formed workpiece support 3 because of the force of gravity. This embodiment is primarily suitable for downward bending for these reasons. However bending upward up to about 200° can also be performed.

The embodiment according to FIG. 2A and FIG. 2B, as already mentioned, has a multipart, here two-part, workpiece support 3. As shown in the drawing, the workpiece support 3 is divided along the bending zone into at least two segments 3a and 3b, which can be moved so that they are at an angle to each other. The movable workpiece support segments 3a and 3b are moved in the required manner according to the desired radius or curvature at the appropriate angle. This motion can occur in a purely mechanical manner, however also by means of N/C (numerically controlled) axes.

FIGS. 2A and 2B also show a mechanical apparatus, which can bend upwards at different angles under a predetermined radius with the green glass panel 1. The stationary segment is connected with the movable segment 3b by means of a roll mechanism 6 with this apparatus.

During the bending process the movable segment 3b of the workpiece support 3 does not rotate around a fixed point, but rolls itself on the stationary segment 3a of the workpiece support 3 by means of a circular segment of the roll mechanism 6. When the glass has the appropriate viscosity during the bending process, the bend radius of the glass corresponds to the radius of the roll segment. In order to prevent slipping, the circular segment and the roll surface can have teeth or can be equipped with a belt or loop. Since the roll plane is in the plane of the glass bearing surface, the glass can be moved without relative motion to the workpiece support surface. The glass is aligned by means of the stop 4.

This apparatus can be modified to provide different size radii in upward and downward bending.

When the movable segment 3b of the workpiece support 3 is moved by means of N/C axes, a high degree of flexibility results. One apparatus can produce upward and downward bending, a variety of different radii and radii behavior with different appropriate angles.

Usually the treatment of the green glass panels corresponds to that, which was explained in connection with FIGS. 1A and 1B, including the heating by a gas burner or the like.

Heating of the deforming zone is especially important in both embodiments.

In the described unit the zone to be deformed is heated by means of cooled gas/oxygen burners 5, which are arranged within the oven chamber 2. The unit and operation of the gas burner 5 is protected by suitable safety devices.

The burners are aligned parallel to the deforming zone and can be moved parallel and perpendicular to the deforming zone, for example along a curvature line. The motion can be performed once or in an oscillatory manner according to the width of the region to be deformed. Complex motions are similarly possible because simple oscillatory motion according to the type of the bending and shaping.

Other heating methods, such as electro-heating and focused IR radiation can be used in addition to the gas/oxygen burners.

The bending or deforming zone is heated at least from one side during bending on the workpiece support 3. In order to achieve a uniform and rapid heating in this region, additional heating of the opposite glass side is conceivable. This additional heating can be provided in the workpiece support 3. Heat can be input through gaps between the movable workpiece support segments 3a and 3b in a multipart movable workpiece support 3.

During the heating by means of the gas/oxygen burner the burner mixture in regard to rate and composition, as well as the spacing between the burner and the glass, are selected in such a way that the heating occurs uniformly and surface damage to the glass is prevented.

In the following several embodiments are described, in which different green glass panels were curved or bent according to the method of the invention, which illustrate the features of the invention:

Green glass panels provided with two gas burner passages and having dimensions of 280 mm×509 mm were bent with this process in a heated chamber: Bent sections 27 mm long were bent upward about 16° (≅196°).

The bend radius amounted to 45 mm.

Green glass panels provided with four gas burner passages and having dimensions of 590 mm×509 mm were bent with this process in a heated chamber: Length of bent section, bend angle and bend radius as above.

Green glass panels provided with five gas burner passages and having dimensions of 801 mm×511 mm were bent with this process in a heated chamber: Length of bent section, bend angle and bend radius as above.

Green glass panels provided with two gas burner passages and having dimensions of 285 mm×516 mm were bent with this process in a heated chamber: Bent sections 26 mm long were bent upward about 21° (≅201°). The bend radius amounted to 40 mm.

Green glass panels having dimensions of 590 mm×509 mm were bent upward with this process: Bent sections 80 mm long were bent upward about 45° (≅225°). The bend radius amounted to 35 mm.

Green glass panels having dimensions of 801 mm×509 mm were bent upward with this process: Bent sections 100 mm long were bent upward about 82°

(≅262°). The bend radius amounted to 23 mm.

Green glass panels having dimensions of 580 mm×600 mm were bent downward with this process: Bent sections 70 mm long were bent downward about 45° (≅135°). The bend radius amounted to 25 mm.

Green glass panels having dimensions of 580 mm×600 mm were bent downward with this process: Bent sections 90 mm long were bent downward about 45°(≅135°). The bend radius amounted to 40 mm.

All panels were stress-free after bending and could be ceramicized in conventional roll ovens with suitable ceramicizing molds.

The disclosure in German Patent Application 100 39 027.7 of Aug. 10, 2000 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in a method for making a curved glass-ceramic panel by bending a green glass panel to be ceramicized and apparatus for performing said method, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. A method of making a curved glass-ceramic panel by bending a green glass panel to be ceramicized, said method comprising the steps of:
a) performing said bending of said green glass panel in a heated chamber at a temperature of from 10° C. to 50° C. above a transformation temperature of the green glass panel to be bent;
b) providing a forming body with a geometric shape according to a bend geometry of the glass-ceramic panel to be formed and tempering said forming body at said temperature of the heated chamber;
c) bringing said forming body into effective mechanical contact with said green glass panel in a bending zone of said green glass panel to form a curved green glass panel;
d) locally heating the green glass panel further in the vicinity of the bending zone; and
e) ceramicizing the curved green glass panel to form the curved glass-ceramic panel.

2. The method as defined in claim 1, further comprising heating said green glass panel in the bending zone on one side thereof or on both sides thereof.

3. The method as defined in claim 2, further comprising heating said green glass panel in the bending zone by means of a gas/oxygen burner.

4. The method as defined in claim 3, wherein said burner is moved in the vicinity of the bending zone according to the bend geometry.

5. The method as defined in claim 4, wherein said burner is oscillated while being moved.

6. The method as defined in claim 3, wherein said green glass panel is additionally heated in the bending zone by means of an electro-heating device or a focused IR radiation source.

7. The method as defined in claim 1, wherein said green glass panel is placed on said forming body and said forming body acts as said workpiece support.

8. An apparatus for making a curved glass-ceramic panel by bending a green glass panel to be ceramicized, said apparatus comprising
a workpiece support (3) having a geometric shape according to a bend geometry for forming the curved glass-ceramic panel;
a heated chamber (2) for heating the workpiece support (3) and the green glass panel at a temperature of from 10° C. to 50° C. above a transformation temperature of the green glass panel to be bent;
heating sources (5) for local heating of the green glass panel further in a bending zone during the bending; and
means for ceramicizing the green glass panel to form the curved glass-ceramic panel.

9. The apparatus as defined in claim 8, wherein said workpiece support (3) is a one piece stationary support having a shape according to the bending to be performed.

10. The apparatus as defined in claim 8, wherein said workpiece support (3) comprises a plurality of segments (3a,3b) and said segments (3a,3b) are movable relative to each other in order to produce an appropriately shaped bend in the green glass panel.

11. The apparatus as defined in claim 10, wherein said segments (3a,3b) are connected with each other by means of a roll mechanism (6) with a circular segment.

12. The apparatus as defined in claim 10, further comprising an N/C controller for controlling said segments (3a,3b) so that said segments (3a,3b) are movable in the N/C axes to provide a predetermined bend radius according to the bending of the green glass panel.
